(19) United States
(12) Patent Application Publication
(10) Pub. No.: US 2022/0343084 A1
(43) Pub. Date: Oct. 27, 2022

(54) TRANSLATION APPARATUS, TRANSLATION METHOD AND PROGRAM

(71) Applicant: NIPPON TELEGRAPH AND TELEPHONE CORPORATION, Tokyo (JP)

(72) Inventors: Masaaki NAGATA, Tokyo (JP); Yuto TAKEBAYASHI, Tokyo (JP); Chenhui CHU, Tokyo (JP); Yuki ARASE, Tokyo (JP)

(73) Assignee: NIPPON TELEGRAPH AND TELEPHONE CORPORATION, Tokyo (JP)

(21) Appl. No.: 17/639,459

(22) PCT Filed: Aug. 25, 2020
(86) PCT No.: PCT/JP2020/032032

§ 371 Date: Mar. 1, 2022

(30) Foreign Application Priority Data
Sep. 2, 2019 (JP) 2019-159663

(51) Int. Cl. G06F 40/49; G06F 40/242; G06F 40/284

(52) U.S. Cl. CPC G06F 40/49; G06F 40/242; G06F 40/284

(57) ABSTRACT

A translation apparatus includes: a preprocessing unit that takes an input sentence in a source language and outputs a token string in which the input sentence has been segmented in tokens, the tokens being a predetermined unit of processing; an output sequence prediction unit that inputs the token string output by the preprocessing unit to a trained translation model and predicts a word translation probability of a translation candidate for each token of the token string from the trained translation model; a word set prediction unit that checks each token of the token string output by the preprocessing unit against entry words of a bilingual dictionary, and upon detecting an entry word that agrees with the token in the bilingual dictionary, generates a target-language word set from a set of tokens constituting a translation phrase corresponding to the detected entry word; and an output sequence determination unit that computes a reward which is based on whether a translation candidate for each token of the input sentence is included in the target-language word set or not and determines a translated sentence of the input sentence based on a word translation score computed by adding the reward to the word translation probability of the translation candidate. Units of tokens constituting the translation phrase in the bilingual dictionary are subwords.

### TECHNICAL FIELD

The present invention relates to neural machine translation.

### BACKGROUND ART

Currently, research and development of neural machine translation using neural networks are proceeding in the field of machine translation. For an exemplary handling of lexicon in neural machine translation, Non-Patent Literature 1 proposes an approach that incorporates a bilingual dictionary in which parallel translations of lexicon are registered into neural machine translation. In this approach, when an output sequence Y=y₁ . . . yₘ is assumed for an input sequence X=x₁ . . . xₙ and the j-th word yⱼ is predicted in a decoder, with respect to the probability of a word xᵢ being translated to a word yⱼ which is determined from a bilingual dictionary with probability:

pₗ(y|x) [Math. 1]

the conditional word translation probability below is considered:

pₗ(yⱼ|y_{<j},X)=Σᵢ₌₁ⁿa_{i,j}pₗ(yⱼ|xᵢ) [Math. 2]

which determines a total sum weighted with an attention (word alignment with probability) a_{i,j} from word position j in an output sentence to position i in an input sentence. As methods of incorporating the conditional word translation probability into a neural machine translation model, Non-Patent Literature 1 proposes two schemes: model biasing and linear interpolation.

In the model biasing, when an output probability:

p(yⱼ|y_{<j},X) [Math. 3]

is calculated at position j in the output sentence from an internal state of the decoder by non-linear transformation, arithmetic manipulation is performed such that as

p₁(yⱼ|y_{<j},X) [Math. 4]

is greater,

p(yⱼ|y_{<j},X) [Math. 5]

will be greater. More specifically, after the internal state of the decoder is linear-transformed, a bias term is added based on the word translation probability and softmax operation is performed.

In the linear interpolation, on the other hand, linear interpolation is performed on:

pₘ(yⱼ|y_{<j},X) [Math. 6]

which is obtained from a translation model, and on:

p₁(yⱼ|y_{<j},X) [Math. 7]

which is derived from a bilingual dictionary.

As another example of handling of lexicon in neural machine translation, Non-Patent Literature 2 proposes grid beam search. The grid beam search involves performing lexically constrained decoding, which uses a neural machine translation model to generate an output sentence which is forced to contain a pre-specified word, rather than in the form of a bilingual dictionary mentioned above.

In the grid beam search, a candidate for a subsequence which is to output a pre-specified phrase is added at each step j, and a candidate for a normal subsequence and a candidate for a subsequence containing the pre-specified phrase are separately maintained for a certain number of beam widths.

### CITATION LIST

### Non-Patent Literature

Non-Patent Literature 1: Philip Arthur, Graham Neubig, and Satoshi Nakamura, “Incorporating discrete translation lexicons into neural machine translation”, In Proceedings of the EMNLP-2016, pp. 1557-1567, 2016.

Non-Patent Literature 2: Chris Hokamp and Qun Liu, “Lexically constrained decoding for sequence generation using grid beam search”, In Proceedings of the ACL-2017, pp. 1535-1546, 2017.

### SUMMARY OF THE INVENTION

### Technical Problem

According to the approach proposed by Non-Patent Literature 1, however, a standard attention-based encoder-decoder model is modified in order to incorporate a bilingual dictionary into a neural machine translation model. Thus, the model needs to be re-learned in order to use the bilingual dictionary or every time the content of the bilingual dictionary is altered. In practical applications, it is desirable to avoid re-learning of a translation model as much as possible because re-learning of a translation model from large-scaled parallel translation data with over millions of sentences requires a couple of days, while a bilingual dictionary is frequently updated. Non-Patent Literature 1 also does not take into account how to handle subwords, which are commonly used in recent neural machine translation, and a way of introducing subwords is not obvious.

In the approach proposed by Non-Patent Literature 2, the number of phrases for forced output that can be practically specified is several at most because the grid beam search requires a computational complexity proportional to the number of constraints. Accordingly, it is not suited for an application where a large number of parallel translations of phrases in input sentences is specified.

In view of the foregoing challenges, an object of the present invention is to provide techniques for constructing a translation model that uses a bilingual dictionary without requiring re-learning of the translation model associated with alteration of the bilingual dictionary.

### Means for Solving the Problem

In order to attain the object, an aspect of the present invention relates to a translation apparatus including: a preprocessing unit that takes an input sentence in a source language and outputs a token string in which the input sentence has been segmented in tokens, the tokens being a predetermined unit of processing; an output sequence prediction unit that inputs the token string output by the preprocessing unit to a trained translation model and predicts a word translation probability of a translation candidate for each token of the token string from the trained translation model; a word set prediction unit that checks each token of the token string output by the preprocessing unit against entry words of a bilingual dictionary, and upon detecting an entry word that agrees with the token in the bilingual dictionary, generates a target-language word set from a set of tokens constituting a translation phrase corresponding to the detected entry word; and an output sequence determination unit that computes a reward which is based on whether a translation candidate for each token of the input sentence is included in the target-language word set or not and determines a translated sentence of the input sentence based on a word translation score computed by adding the reward to the word translation probability of the translation candidate. Units of tokens constituting the translation phrase in the bilingual dictionary are subwords.

### Effects of the Invention

The present invention enables construction of a translation model that uses a bilingual dictionary without requiring re-learning of the translation model associated with alteration of the bilingual dictionary.

### BRIEF DESCRIPTION OF DRAWINGS

FIG. 1 is a schematic diagram showing a translation apparatus according to an embodiment of the present invention.

FIG. 2 is a block diagram showing a hardware configuration of a translation apparatus according to an embodiment of the present invention.

FIG. 3 is a block diagram showing a functional configuration of a translation apparatus according to an embodiment of the present invention.

FIG. 4 is a schematic diagram showing generation processing of a target language word set according to an embodiment of the present invention.

FIG. 5 is a schematic diagram showing reward addition processing according to an embodiment of the present invention.

FIG. 6 is a flowchart illustrating translation processing according to an embodiment of the present invention.

FIG. 7 shows results of evaluation according to an embodiment of the present invention.

### DESCRIPTION OF EMBODIMENTS

A translation apparatus according to an embodiment of the present invention is described below with reference to the drawings. The translation apparatus according to an embodiment described below has a bilingual dictionary indicating entry words in a source language and translation phrases in a target language, and upon taking an input sentence to be translated, searches the bilingual dictionary for any entry word that matches each of tokens of the input sentence in the bilingual dictionary. If it detects an entry word matching the token in the bilingual dictionary, the translation apparatus adds a translation phrase corresponding to the detected entry word to a target-language word set. Then, the translation apparatus determines a word translation probability of a translation candidate for each token of the input sentence such as by using a trained machine learning model. If the translation candidate for a token of the input sentence is included in the target-language word set, the translation apparatus generates a translated sentence of the input sentence by determining the translation candidate for each token based on a word translation score computed by adding a reward to the word translation probability of the translation candidate.

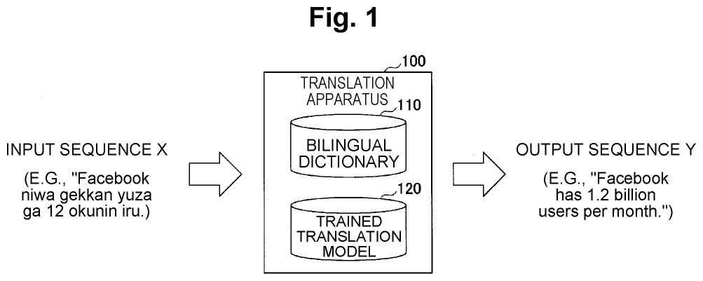

FIG. 1 is a schematic diagram showing a translation apparatus according to an embodiment of the present invention. As shown in FIG. 1, a translation apparatus 100 takes as an input sequence X an input sentence in the source language to be translated and generates an output sentence in the target language as an output sequence Y using a bilingual dictionary 110 and a trained translation model 120, which may be implemented as a trained machine learning model. In the illustrated embodiment, the source language is Japanese and the target language is English. For example, given an input sentence to be translated, “Facebook niwa gekkan yuza ga 12 okunin iru.”, the translation apparatus 100 will output “Facebook has 1.2 billion users per month.”

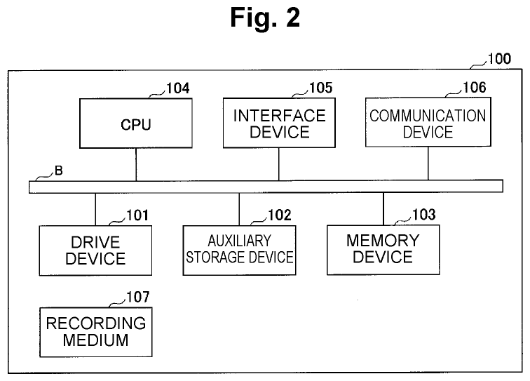

The translation apparatus 100 may be implemented in a computing device, e.g., a smartphone, a tablet, a personal computer (PC) or a server, and may have a hardware configuration such as shown in FIG. 2, for example. That is, the translation apparatus 100 includes a drive device 101, an auxiliary storage device 102, a memory device 103, a CPU (Central Processing Unit) 104, an interface device 105 and a communication device 106, which are interconnected via a bus B.

Various computer programs including a program for implementing various functions and processes in the translation apparatus 100 as discussed later may be provided through a recording medium 107, such as a CD-ROM (Compact Disk-Read Only Memory). When the recording medium 107 with the program stored thereon is set in the drive device 101, the program is installed into the auxiliary storage device 102 from the recording medium 107 via the drive device 101. However, installation of the program needs not necessarily be done through the recording medium 107 but may be downloaded from some external device over a network and the like. The auxiliary storage device 102 stores the installed program as well as necessary files and data. The memory device 103 reads and stores the program or data from the auxiliary storage device 102 upon an instruction for starting the program. The CPU 104 functioning as a processor performs various functions and processing of the translation apparatus 100 in accordance with the program stored in the memory device 103 and various data such as parameters required for execution of the program. The interface device 105 is used as a communication interface for connecting to a network or an external device. The communication device 106 executes various kinds of communication processing for communicating with a terminal or an external device. However, the translation apparatus 100 is not limited to the above hardware configuration and may be implemented with any other suitable hardware configuration.

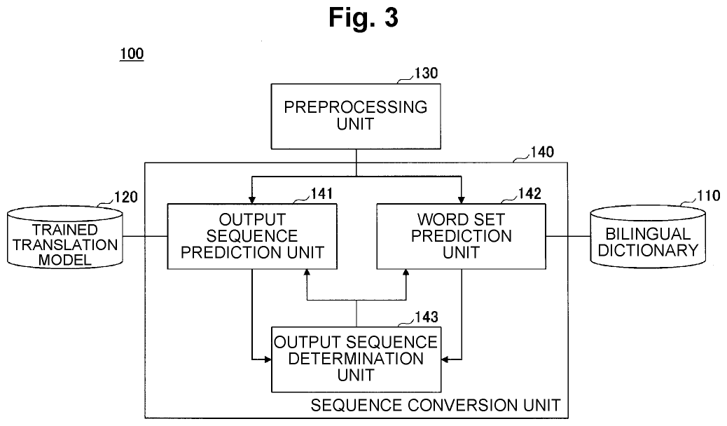

FIG. 3 is a block diagram showing a functional configuration of the translation apparatus 100 according to an embodiment of the present invention. As shown in FIG. 3, the translation apparatus 100 includes a preprocessing unit 130 and a sequence conversion unit 140.

The preprocessing unit 130 takes an input sentence in the source language and outputs a token string in which the input sentence has been segmented in tokens, where the tokens are a predetermined unit of processing. In this embodiment, the predetermined unit of processing is either word or subword. For segmenting an input sentence into a word token string, common processing such as morphological analysis may be performed. The translation apparatus 100 according to this embodiment is also applicable to a subword token string which has been segmented by byte pair encoding and the like.

A problem of neural machine translation is that it is unable to address large-scaled lexicon because it requires computational complexity dependent on the size of lexicon, particularly for text generation in the decoder. For example, if the lexicon is limited only to high-frequency words in order to control computational complexity, it gives rise to the problem of impossibility of handling low-frequency words.

As such, it is possible to segment low-frequency words into shorter words, called subwords, or partial character strings and handle them as the basic unit of input and output while leaving high-frequency words intact, limit the size of lexicon below a predefined threshold (typically tens of thousands), and represent a low-frequency word as a sequence of subwords with relatively high frequency, thus substantially reducing unknown words.

As an example, when the word “Facebook” is not included in the lexicon, it will be segmented into a sequence of subwords having relatively high frequency of occurrence, such as “Face@@” and “book”. Further, by adding a special symbol string like “@@” at the end of a subword, a sequence of subwords can be easily reconstructed into the original word. While several ways of determining such subwords have been proposed, the most common one is byte pair encoding (BPE: Rico Sennrich, Barry Haddow, and Alexandra Birch, “Neural machine translation of rare words with subword units”, In Proceedings of the ACL-2016, pp. 1715-1725, 2016).

For example, when “Facebook niwa gekkan yuza ga 12 okunin iru.” is taken as the input sentence, it is first segmented into a token string: “Facebook/ni/wa/gekkan/yuza/ga/12/oku/nin/iru.” Further, by byte pair encoding or the like, the input sentence is segmented into a subword string: “Face@@/book/ni/wa/gekkan/yu@@/za/ga/12/oku/nin/iru.”, which is then output by the preprocessing unit 130 as a token string.

The sequence conversion unit 140 converts the token string output by the preprocessing unit 130 to a translated sentence of the input sentence. Specifically, the sequence conversion unit 140 includes an output sequence prediction unit 141, a word set prediction unit 142 and an output sequence determination unit 143.

The output sequence prediction unit 141 inputs the token string output by the preprocessing unit 130 to the trained translation model 120 and predicts the word translation probability of a translation candidate for each token of the token string from the trained translation model 120.

For example, the word translation probability of a translation candidate may be obtained from a trained machine learning model that outputs a word as the translation candidate along with a word translation probability indicating a likelihood of that word. That is, when words are generated one by one as a translated sentence starting at the beginning of the sentence toward the end thereof, the trained machine learning model outputs the following as a conditional probability for the j-th word yⱼ:

log p(yⱼ|y_{<j},X;θ) [Math. 8]

The machine learning model of the output sequence prediction unit 141 may be any model that has been trained beforehand by a general method as described later. This embodiment is described for a case where word translation probability is determined using an attention-based encoder-decoder model, which is the mainstream of the current neural machine translation (Dzmitry Bandanau, Kyunghyun Cho, and Yoshua Bengio, “Neural machine translation by jointly learning to align and translate”, In Proceedings of the ICLR-2015, 2015., Thang Luong, Hieu Pham, and Christopher D. Manning, “Effective approaches to attention-based neural machine translation”, In Proceedings of the EMNLP-2015, pp. 1412-1421, 2015), as the machine learning model of the output sequence prediction unit 141. For an attention-based encoder-decoder model, the likelihood of the output sequence Y=y₁ . . . yₘ with respect to the input sequence X=x₁ . . . xₙ is formulated as:

log p(Y|X;θ)=Σⱼ₌₁^{m} log p(yᵢ|y_{<j},X;θ) [Math. 9]

where θ is a parameter of the model, and

y_{<j}=y₁ . . . yⱼ₋₁ [Math. 10]

is an output sequence from the first output to the j-1 th output. Here, the j-1 th output is assumed to be obtained by the output sequence determination unit 143, to be discussed later.

In the model, the encoder is a recurrent neural network that maps the input sequence X to an internal state sequence (states of hidden layers) H=h₁ . . . hₙ by non-linear transformation and the decoder is a recurrent neural network that predicts the output sequence Y one by one starting at the first one. The probability of the j-th output word yⱼ is:

p(yⱼ|y_{<j},X;θ) [Math. 11]

Here, it is assumed that the parameter θ of the encoder-decoder model is learned in advance so as to, using stochastic gradient descent or SGD, minimize a cross-entropy loss L_{θ} for parallel translation data C={(X, Y)}:

$${L}_{θ} = - {\sum }_{( X , Y ) ∈ C} log p ( Y \vert X ; θ ) \qquad [ Math . 12 ]$$

The attention-based encoder-decoder model is an encoder-decoder model having a feed-forward neural network called an attention layer. The attention layer calculates a weight a_{i,j} for an internal state hᵢ of the encoder corresponding to the word xᵢ in the source language, which is used in prediction of the next word yⱼ from the immediately preceding word yⱼ₋₁ in the target language.

In neural machine translation, attention is determined by normalizing a degree of similarity between the internal state of the encoder corresponding to each word in the input sentence and the internal state of the decoder corresponding to the next word in the output sentence, and can be considered to be word alignment with probability in neural machine translation.

The word set prediction unit 142 checks each token of the token string output by the preprocessing unit 130 against the entry words of the bilingual dictionary 110 and upon detecting an entry word that agrees with the token in the bilingual dictionary 110, it generates a target-language word set from a set of tokens constituting the translation phrase corresponding to the detected entry word. Here, the bilingual dictionary 110 is made up of pairs of a word in the source language as an entry word and its translation phrase in the target language. Specifically, when the source language is Japanese and the target language is English, words (tokens) in Japanese and one or more translation phrases (a token set) in English corresponding to them are registered in the bilingual dictionary 110. For example, a Japanese word “yuza” and corresponding translation phrases in English “user” and “users” can be registered in the bilingual dictionary 110. Then, if the word “yuza” is included in the input sentence, the bilingual dictionary 110 will be searched for any registration of the Japanese entry word “yuza”, which agrees with the word “yuza” of the input sentence.

The word set prediction unit 142 acquires a token string from the preprocessing unit 130 and checks each token included in the token string against the entry words of the bilingual dictionary in the bilingual dictionary 110. If it detects an entry word agreeing with the token in the bilingual dictionary 110, it adds the translation phrase corresponding to the detected entry word to the target-language word set. Herein, a case of using “exact match” as the method of checking tokens against the entry words of the bilingual dictionary is described as an embodiment. For example, upon taking the token string “Facebook niwa gekkan yuza ga 12 okunin iru.” the word set prediction unit 142 detects registration of “yuza” as an entry word of the bilingual dictionary and adds the translation phrases “user” and “users” corresponding to the detected entry word “yuza” to a target-language word set D_{f2e}.

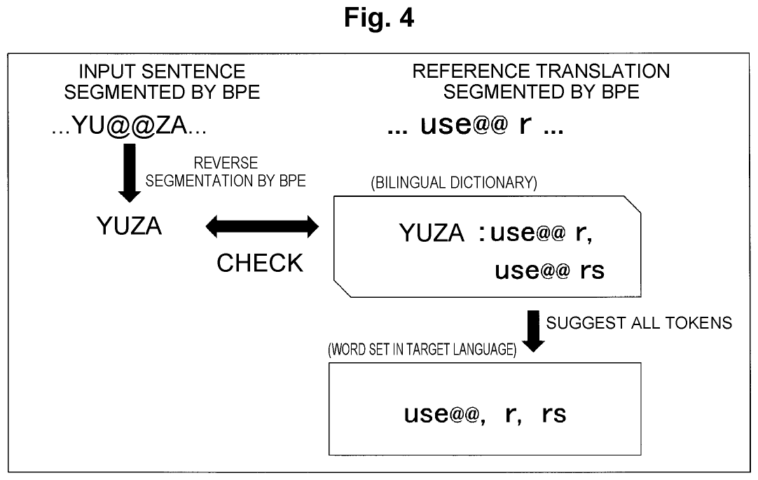

As an embodiment, the word set prediction unit 142 is also applicable to a subword string which has been segmented by byte pair encoding and the like. For example, when a sentence that contains subwords in tokens is taken as a token string, like: “Face@@/book/ni/wa/gekkan/yu@@/za/ga/12/oku/nin/iru.”, the word set prediction unit 120 reconstructs the original words from the token string, like: “Facebook/ni/wa/gekkan/yuza/ga/12/oku/nin/iru.”, and checks it against the entry words of the bilingual dictionary based on the reconstructed words. Then, if registration of “yuza” as an entry word of the bilingual dictionary 110 is detected, translation subwords “use@@”, “r”, and “rs” corresponding to the detected entry word “yuza” are added to the target-language word set D_{f2e} as shown in FIG. 4. While in the foregoing specific example subwords are present both on the source language side and the target language side, the present invention is not limited thereto; only either one of the source word side and the target word side may be subwords.

In this manner, the bilingual dictionary 110 may include translation phrases in the target language or translation subwords of translation phrases. When the word set prediction unit 142 detects in the bilingual dictionary 110 an entry word (e.g., “yuza”) corresponding to the original word reconstructed from a subword (e.g., “yu@@za”) which was acquired by segmentation of the input sentence by byte pair encoding or the like, it may add translation subwords (e.g., “use@@”, “r”, “rs”) corresponding to the detected entry word to the target-language word set D_{f2e}.

Agreement as called herein may be either exact match or partial match. In the above embodiment, the word set prediction unit 142 added “yuza” to the target-language word set D_{f2e} when the token “yuza” of the input sentence exactly matches the entry word “yuza” of the bilingual dictionary 110. The word set prediction unit 142 may also add the token set that constitutes the phrase in question to the target-language word set D_{f2e} when a token of the input sentence partially matches an entry word of the bilingual dictionary 110.

For example, assume that the entry word “nyu-raru kikai hon-yaku” and the translation phrase “neural machine translation” are registered in the bilingual dictionary. Further assume that “nyu-raru kikai hon-yaku” in the input sentence has been segmented into subwords “nyu-raru@@kikai hon-yaku” by byte pair encoding. In partial match, if the subword “kikai hon-yaku” is present in the input sentence, the word set prediction unit 120 may determine that the subword “kikai hon-yaku” partially matches the entry word “nyu-raru kikai hon-yaku” and add the set of the tokens constituting the translation phrase, “neural”, “machine”, “translation”, to the target-language word set D_{f2e}. For example, the degree of match here may be defined as a ratio of the number of matching words to the number of words in a phrase, and a match may be regarded as partial match when the degree of match is a predetermined value or above.

Agreement or non-agreement may be defined based on the number of matching subwords or a predetermined token translation probability. In other words, filtering by the number of matching subwords or filtering by probability may be performed. In checking tokens against the entry words of the bilingual dictionary, the number of words to be added to the target-language word set D_{f2e} can be narrowed down using the number of tokens in the target language for one word in the input sentence or a word (token) translation probability determined from parallel translation data by the use of a statistical translation tool such as Giza++.

The output sequence determination unit 143 computes a reward which is based on whether the translation candidate for each token of the input sentence is included in the target-language word set or not, and determines translation candidates corresponding to the input sentence and the final translated sentence based on a word translation score computed by adding the reward to the word translation probability of a translation candidate computed by the output sequence prediction unit 141.

For example, when the j-th word yⱼ of the input sentence is predicted by the output sequence prediction unit 141, the output sequence determination unit 143 determines whether a translation candidate for the word yⱼ is included in target-language word set D_{f2e}. If the translation candidate is included in the target-language word set D_{f2e}, the output sequence determination unit 143 then adds a reward to the word translation probability for the translation candidate, increasing the word translation score according to which the translation candidate included in the target-language word set D_{f2e} is adopted in a translated sentence.

Specifically, the output sequence determination unit 143 computes a word translation score Q defined by:

Q(yⱼ|y_{<j},X)=log p(yⱼ|y_{<j},X;θ)+λr_{y}_{ⱼ} [Math. 13]

where r_{yj} is the reward for the j-th translation candidate and λ is a weight for the reward. The reward r_{yj} is defined by:

$${r}_{yj} = \{ \begin{matrix}1 & ( {y}_{j} ∈ {D}_{f 2 e} ) , \\ 0 & ( otherwise )\end{matrix} . \qquad [ Math . 14 ]$$

which means that when the translation candidate is included in the target-language word set, the output sequence determination unit 143 determines a word translation score weighted with the weight λ:

log p(yⱼ|y_{<j},X;θ)+λr_{y}_{ⱼ} [Math. 15]

as the word translation score Q of the translation candidate for the j-th word yⱼ. When the translation candidate is not included in the target-language word set, the output sequence determination unit 143 determines the word translation probability:

log p(yⱼ|y_{<j},X;θ) [Math. 16]

as the word translation score Q of the translation candidate for the j-th word yⱼ without adding the weight λ.

Then, the output sequence determination unit 143 generates a translation candidate sequence that maximizes the total sum of the word translation scores Q for the input sentence as a translated sentence. Specifically, in generation of a translated sentence, processing may be performed with the word translation probability in general decoding replaced by the word translation score Q;

log p(yⱼ|y_{<j},X;θ)+λr_{y}_{ⱼ} [Math. 17]

In general decoding, an output sequence that gives the maximum probability for the input sequence X under the model parameter θ is determined:

Ŷ [Math. 18]

The probability of the output sequence Y is determined by generating words one by one from the beginning of the sentence toward the end thereof and multiplying the conditional generation probabilities of the respective words:

$$\hat{Y} = arg {max}_{Y} log p ( Y \vert X ; θ ) = arg {max}_{Y} {\sum }_{j = 1}^{m} log p ( {y}_{j} \vert {y}_{< j} , X ; θ ) \qquad [ Math . 19 ]$$

That is, the output sequence determination unit 143 determines as the translated sentence of the input sequence X an output sequence that maximizes the sum of the word translation scores Q for the input sequence X:

$$\hat{Y} = arg {max}_{Y} {\sum }_{j = 1}^{m} Q ( {y}_{j} \vert {y}_{< j} , X ) \qquad [ Math . 20 ]$$

In doing so, beam search may also be performed. In beam search, when the beam width is N, subsequence candidates with the top N generation probabilities for the subsequence y₁ . . . yⱼ are kept and the other candidates are removed at step j.

The reward r_{yj} needs not necessarily be derived from a machine learning model and may be determined from parallel translation data using a statistical translation tool such as Giza++, for example.

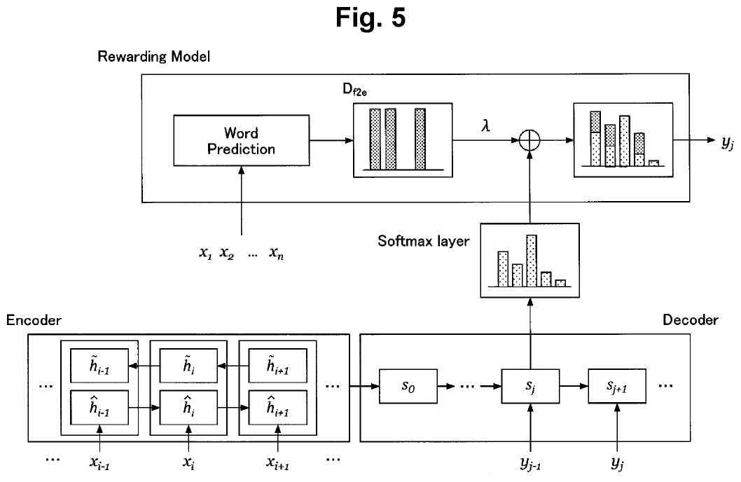

The translation apparatus 100 described above may be implemented in an architecture such as shown in FIG. 5, for example. That is, the output sequence prediction unit 141 corresponds to Encoder and Decoder, the word set prediction unit 142 to Word Prediction, and the output sequence determination unit 143 to Rewarding Model. FIG. 5 shows an example of processing in decoding of the j-th word (for the simplicity of illustration, Attention mechanism and the like are not shown). That is, the word translation probability of a translation candidate output by Decoder is added to a reward (in the illustrated example, 0 or a predetermined positive value λ) which is derived according to whether the candidate is included in the target-language word set D_{f2e} or not, and an output sentence is determined based on the word translation score after the addition.

As shown, Encoder performs encoding in both directions, i.e., temporally forward encoding:

ĥᵢ₋₁,ĥᵢ,ĥᵢ₊₁ [Math. 21]

and temporally backward encoding:

\tilde{h}ᵢ₋₁,\tilde{h}ᵢ,\tilde{h}ᵢ₊₁ [Math. 22]

and the result of encoding is processed by Decoder and output to Rewarding Model. In Rewarding Model, the reward based on the target-language word set D_{f2e} generated by Word Prediction is added to the word translation probability output by Decoder, and a translated sentence is generated according to the word translation score after the addition of the reward.

In this manner, by adding reward after predicting the word translation probability with the trained translation model 120, the word translation scores of words registered in the bilingual dictionary are increased to promote translation to registered translations. Thus, translation processing based on the modified bilingual dictionary 110 can be executed without re-learning of the trained translation model 120.

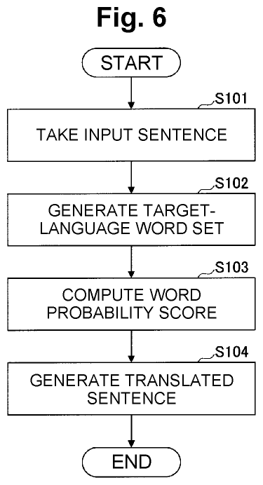

FIG. 6 is a flowchart illustrating translation processing according to an embodiment of the present invention. The translation processing is executed by the translation apparatus 100 and may be implemented by a program that causes a processor to run as functional components of the translation apparatus 100, for example.

As shown in FIG. 6, at step S101, the translation apparatus 100 takes an input sentence in the source language and outputs a token string in which the input sentence has been segmented in tokens, where the tokens are a predetermined unit of processing. For example, when the source language is Japanese and the target language is English, the translation apparatus 100 takes an input sentence in Japanese to be translated into English, such as “Facebook niwa gekkan yuza ga 12 okunin iru.”, and outputs a token string “Face@@/book/ni/wa/gekkan/yu@@za/ga/12/oku/nin/iru”.

At step S102, if the translation apparatus 100 detects an entry word matching a token of the output token string in the bilingual dictionary 110, it generates a target-language word set from the translation phrases corresponding to the detected entry word. For example, the translation apparatus 100 checks whether a word reconstructed from tokens is included in the entry words of the prepared bilingual dictionary 110, and if an entry word matching the word reconstructed from tokens is included in the bilingual dictionary 110, adds the translation phrase corresponding to the detected entry word to the target-language word set. For example, if the entry word “yuza” and the translation phrases “use@@r” and “use@@rs” are included in the bilingual dictionary 110, the translation apparatus 100 adds the translation phrases “use@@r” and “use@@rs” to the target-language word set.

At step S103, the translation apparatus 100 computes the word translation score of a translation candidate. For example, the translation apparatus 100 determines the word translation probability of the translation candidate for each token of the input sentence with the prepared trained translation model 120. If the determined translation candidate is included in the target-language word set, the translation apparatus 100 adds a reward to the word translation probability of the translation candidate and determines it to be the word translation score Q after the addition of the reward. If the determined translation candidate is not included in the target-language word set, the translation apparatus 100 uses the word translation probability of the translation candidate as the word translation score Q without adding a reward.

At step S104, the translation apparatus 100 determines the translation phrases for the respective tokens of the token string based on the word translation scores Q of the translation candidates and generates a translated sentence from the determined translation phrases. Specifically, the translation apparatus 100 determines such a translation candidate string that maximizes the total sum of the word translation scores Q for the output sequence Y and determines the determined translation candidate string as a translated sentence.

By making use of the bilingual dictionary 110, the translation apparatus 100 described above improves translation accuracy compared to when the bilingual dictionary 110 is not used. For example, assume that for the input sentence “Facebook niwa gekkan yuza ga 12 okunin iru.”, the word “gekkan” is translated to “per year” because it was not included in the training data of the prepared trained translation model 120. By contrast, if the entry word “gekkan” and the translation phrase “per month” are included in the bilingual dictionary 110, “month” will be included in a predicted target-language word set, therefore a reward is added to the word and the word is more likely to be correctly translated to “per month”.

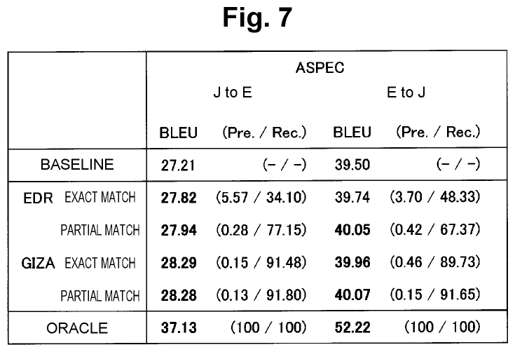

Now referring to FIG. 7, results of evaluation related to translation accuracy are described. FIG. 7 shows the results of evaluation according to an embodiment of the present invention. FIG. 7 shows the results of an experiment with the present invention that utilized a corpus of Japanese-English scientific paper abstracts (ASPEC-JE) published by Japan Science and Technology Agency (JST).

The experiment used the first two million sentences with less noise from three million sentences of training data in accordance with an earlier study (Makoto Morishita, Jun Suzuki, and Masaaki Nagata, “Ntt neural machine translation systems at wat 2017”, In Proceedings of the WAT-2017, 2017). For bilingual dictionaries, EDR Electronic Dictionary was used as a manually created bilingual dictionary, and a bilingual dictionary created from the same ASPEC corpus using the statistical translation tool Giza++ was used as an automatically generated bilingual dictionary. Herein, the former is called EDR and the latter is called GIZA.

Baseline is a similar system to the one described in Makoto Morishita, Jun Suzuki, and Masaaki Nagata, “Ntt neural machine translation systems at wat 2017”, In Proceedings of the WAT-2017, 2017. The system is one that won the top ranking in both Japanese to English and English to Japanese translation in WAT-2017, a shared task of translation using the scientific paper abstract corpus ASPEC.

EDR and GIZA indicate that the EDR Electronic Dictionary and a bilingual dictionary created from a parallel translation corpus using Giza++ were used as the bilingual dictionaries in the present invention, and exact match and partial match indicate that exact match and partial match were used in prediction of a target-language word set in the present invention.

Translation accuracy was evaluated with BLEU, an automated evaluation measure. Also, for evaluation of the quality of the bilingual dictionaries, recall and precision of a word set which were obtained by target language prediction with respect to a word set of a reference translation are shown.

Oracle is translation accuracy in the case of using a word set acquired from the reference translation instead of the prediction of a target-language word set in the present invention, and in this case the recall and the precision of the bilingual dictionaries are both 100%.

Comparing Baseline and the proposed approach, translation accuracy is improved both in the case of using a manually created bilingual dictionary (EDR) and the case of using an automatically generated bilingual dictionary (GIZA). Accuracy is slightly higher with partial match than with exact match. This improvement in translation accuracy is largely due to improvement in the recall of prediction of the target-language word set via partial match, particularly when a manually created dictionary is used.

Further, comparing the proposed approach and Oracle, as the translation accuracy of Oracle is very high, it is expected that translation accuracy can be enhanced by further improving the recall and precision of prediction of the target-language word set.

While the embodiments of the present invention have been described in detail, the present invention is not limited to the particular embodiments described above. Various variations and modifications may be made within the scope of the present invention as set forth in the claims.

### REFERENCE SIGNS LIST

100 translation apparatus
110 bilingual dictionary
120 trained translation model
130 preprocessing unit
140 sequence conversion unit
141 output sequence prediction unit
142 word set prediction unit
143 output sequence determination unit

1. A translation apparatus comprising a processor configured to execute a method comprising:
receiving an input sentence in a source language;
outputting a token string in which the input sentence has been segmented in tokens, the tokens being a predetermined unit of processing;
inputting the token string output to a trained translation model;
predicting a word translation probability of a translation candidate for each token of the token string from the trained translation model;
checking each token of the token string against entry words of a bilingual dictionary;
generating, upon detecting an entry word that agrees with the token in the bilingual dictionary, a target-language word set from a set of tokens including a translation phrase corresponding to the detected entry word;
computing a reward which is based on whether a translation candidate for each token of the input sentence is included in the target-language word set or not; and
determining a translated sentence of the input sentence based on a word translation score computed by adding the reward to the word translation probability of the translation candidate,
wherein units of tokens including the translation phrase in the bilingual dictionary are subwords.

2. The translation apparatus according to claim 1, wherein the token string of the input sentence includes a subword, and the processor further configured to execute a method comprising:
reconstructing the subword into an original word; and
checking the reconstructed word against the entry words of the bilingual dictionary.

3. The translation apparatus according to claim 1, the processor further configured to execute a method comprising:
performing the checking based on any of “exact match”, “partial match”, “the number of matching subwords”, or “a predetermined token translation probability”; and
generating the target-language word set.

4. A computer-implemented method for translating, the method comprising:
receiving an input sentence in a source language;
outputting a token string in which the input sentence has been segmented in tokens, the tokens being a predetermined unit of processing;
inputting the output token string to a trained translation model;
predicting a word translation probability of a translation candidate for each token of the token string from the trained translation model;
checking each token of the output token string against entry words of a bilingual dictionary;
generating, upon detecting an entry word that agrees with the token in the bilingual dictionary, a target-language word set from a set of tokens constituting a translation phrase corresponding to the detected entry word;
computing a reward which is based on whether a translation candidate for each token of the input sentence is included in the target-language word set or not; and
determining a translated sentence of the input sentence based on a word translation score computed by adding the reward to the word translation probability of the translation candidate,
wherein units of tokens constituting the translation phrase in the bilingual dictionary are subwords.

5. A computer-readable non-transitory storage medium storing computer-executable program instructions that when executed by a processor cause a computer system to execute a method comprising:
receiving an input sentence in a source language;
outputting a token string in which the input sentence has been segmented in tokens, the tokens being a predetermined unit of processing;
inputting the output token string to a trained translation model;
predicting a word translation probability of a translation candidate for each token of the token string from the trained translation model;
checking each token of the output token string against entry words of a bilingual dictionary;
generating, upon detecting an entry word that agrees with the token in the bilingual dictionary, a target-language word set from a set of tokens constituting a translation phrase corresponding to the detected entry word;
computing a reward which is based on whether a translation candidate for each token of the input sentence is included in the target-language word set or not and
determining a translated sentence of the input sentence based on a word translation score computed by adding the reward to the word translation probability of the translation candidate,
wherein units of tokens constituting the translation phrase in the bilingual dictionary are subwords.

6. The translation apparatus according to claim 1, wherein the bilingual dictionary indicates a target word in the target language based on a source word in the source language.

7. The translation apparatus according to claim 1, wherein the trained translation model is based on a machine learning model using a recurrent neural network.

8. The translation apparatus according to claim 1, wherein the trained translation model includes an encoder-decoder model having a feed-forward neural network.

9. The translation apparatus according to claim 1, wherein the adding the reward to the word translation probability of the translation candidate excludes re-training of the trained translation model.

10. The computer-implemented method according to claim 4, wherein the token string of the input sentence includes a subword, and the method further comprising:
reconstructing the subword into an original word; and
checking the reconstructed word against the entry words of the bilingual dictionary.

11. The computer-implemented method according to claim 4, the method further comprising:
performing the checking based on any of “exact match”, “partial match”, “the number of matching subwords”, or “a predetermined token translation probability”; and
generating the target-language word set.

12. The computer-implemented method according to claim 4, wherein the bilingual dictionary indicates a target word in the target language based on a source word in the source language.

13. The computer-implemented method according to claim 4, wherein the trained translation model is based on a machine learning model using a recurrent neural network.

14. The computer-implemented method according to claim 4, wherein the trained translation model includes an encoder-decoder model having a feed-forward neural network.

15. The computer-readable non-transitory storage medium according to claim 5, wherein the token string of the input sentence includes a subword, and the computer-executable program instructions when executed further cause a computer system to execute a method comprising:
reconstructing the subword into an original word; and
checking the reconstructed word against the entry words of the bilingual dictionary.

16. The computer-readable non-transitory storage medium according to claim 5, the computer-executable program instructions when executed further cause a computer system to execute a method comprising:
performing the checking based on any of “exact match”, “partial match”, “the number of matching subwords”, or “a predetermined token translation probability”; and
generating the target-language word set.

17. The computer-readable non-transitory storage medium according to claim 5, wherein the bilingual dictionary indicates a target word in the target language based on a source word in the source language.

18. The computer-readable non-transitory storage medium according to claim 5, wherein the trained translation model is based on a machine learning model using a recurrent neural network.

19. The computer-readable non-transitory storage medium according to claim 5, wherein the trained translation model includes an encoder-decoder model having a feed-forward neural network.

20. The computer-readable non-transitory storage medium according to claim 5, wherein the adding the reward to the word translation probability of the translation candidate excludes re-training of the trained translation model.
